(19) United States
(12) Patent Application Publication
(10) Pub. No.: US 2005/0226293 A1
(43) Pub. Date: Oct. 13, 2005

(54) Automatic laser power control method and apparatus for an optical recording system

(75) Inventors: Hsin-Chung Yeh, Taipei Hsien (TW); Chih-Chin Hsu, Taipei Hsien (TW)

Correspondence Address: MCNEES, WALLACE & NURICK LLC, 100 PINE STREET, P.O. BOX 1166, HARRISBURG, PA, 17108-1166, US

(73) Assignee: MEDIATEK INC., His-Chu City (TW)

(21) Appl. No.: 11/092,651

(22) Filed: Mar. 29, 2005

(30) Foreign Application Priority Data
Apr. 12, 2004 (TW) 93110057

(51) Int. Cl. H01S 3/00

(52) U.S. Cl. 372/38.02; 372/38.01

(57) ABSTRACT

An automatic laser power control apparatus for an optical recording system includes a drive voltage generator and a control unit. The drive voltage generator amplifies a selected control voltage or target value for output. When the control voltage is selected by the drive voltage generator, the apparatus works in a closed-loop control mode. When a recording or reading process is interrupted, the control unit generates a calculated variable gain value based on operation parameters, such as the drive voltage, the control voltage, the variable gain value and the target value, prior to interruption. At the end of interruption, the control unit enables the drive voltage generator to generate the requisite drive voltage according to the recording speed and link point condition, thereby generating the voltage or control state that approximates the closed-loop condition so that there is almost zero transient response in the system.

### CROSS-REFERENCE TO RELATED APPLICATION

This application claims priority of Taiwanese application no. 093110057, filed on Apr. 12, 2004.

### BACKGROUND OF THE INVENTION

1. Field of the Invention

The invention relates to a method and apparatus for controlling laser power automatically, especially to a control method and apparatus that makes zero transient response output possible during laser power switching and that can be applied to operating environments where the control target value is variable.

2. Description of the Related Art

Referring to FIG. 1, a conventional automatic laser power control apparatus 10 of an optical recording system 1 is shown to be adapted for generating a drive voltage (V_{d}) that is supplied to a laser diode driver 11 so as to drive a laser diode 13 of an optical pickup 12.

The control apparatus 10 includes a control voltage generator 14 and a variable gain amplifier 15. The control voltage generator 14 is adapted for generating a control voltage (V_{c}) with reference to a target value (V_{g}) (normally a voltage value) and a feedback value (V_{f}) (normally a voltage value). The control voltage (V_{c}) is amplified by the variable gain amplifier 15 to generate the drive voltage (V_{d}), which is supplied to the laser diode driver 11. Thereafter, through voltage-current conversion, the laser diode 13 will be driven by the laser diode driver 11 to generate a laser power corresponding to the drive voltage (V_{d}). The feedback value (V_{f}) is obtained via a sample-and-hold (S/H) circuit 17. In particular, an optical power detector 16 detects the laser power of the laser diode 13. The S/H circuit 17 samples and holds the output of the optical power detector 16 to result in the feedback value (V_{f}).

In the optical recording system 1, since the magnitude and form of the laser power are different when the optical recording system 1 is operated in the record mode and in the read mode, there is a need for laser power switching between the two modes. For instance, when the optical recording system 1 operates in the record mode and then encounters a “buffer-under-run” condition (i.e., the data transmission speed of a host is too slow, thus leading to insufficient data for recording), the recording operation is not able to proceed further. At this time, the optical recording system 1 interrupts the control apparatus 10 used in the record mode to stop generating the drive voltage (V_{d}), and operation is switched from the record mode to the read mode. When the recording data eventually becomes sufficient, operation is switched back to the record mode to continue with the recording operation. However, when switching from the read mode back to the record mode, if the control apparatus 10 is activated by changing the target value (V_{g}) directly, the laser power at the instant of activation will generate a transient response shown in FIG. 2. Data recorded during the transient period 21 is unlikely to be read back well in view of poor recording quality due to the transient laser power.

EP 1231602 discloses a method for eliminating transient response through compensation control. As shown in FIG. 3, before the automatic power control (APC) device is activated in closed-loop (which is constituted in sequence by an optical pickup 301, a sample-and-hold (S/H) circuit 306, an amplifier 305, an adder 304, a laser diode driver 302, and back to the optical pickup 301), an open-loop (which is constituted in sequence by a controller 303, the adder 304, the laser diode driver 302 and the optical pickup 301) is formed, and the controller 303 provides a compensation voltage signal (V_{com}) to the laser diode driver 302 for outputting a laser power. After a specified time period, the APC closed-loop is activated, thereby reducing the transient response time required by the APC closed-loop.

However, in EP 1231602, the compensation voltage signal (V_{com}) must be obtained beforehand in the aforesaid method. If the compensation voltage signal (V_{com}) was not calculated accurately enough, the laser power will generate a period of transient response, such as that shown in FIG. 4, which can lead to jitter problem of the recorded data. Moreover, since the compensation voltage signal (V_{com}) was obtained beforehand, the aforesaid compensation scheme is only applicable to cases where the target value is fixed (such as the CLV record mode), and is not applicable in situations where the target value is variable (such as the CAV record mode). In particular, when the optical recording system operates in the CAV record mode, the control target value will vary continuously with the recording speed, and the required compensation voltage signal should vary as well. However, in the aforesaid scheme, since real-time adjustment of the compensation voltage signal during the CAV record mode is not possible, the proposed scheme is not applicable to environments where the control target value is variable.

### SUMMARY OF THE INVENTION

Therefore, the object of the present invention is to provide a method and apparatus for controlling laser power automatically, in which control status is dynamically observed and saved, and variable gain for laser power switching is generated based on the saved control status, thereby eliminating transient response and adapting to environments where the target value changes dynamically.

According to one aspect of the invention, there is provided an automatic laser power control method, which can be used in an optical recording system to generate a drive voltage for causing a laser diode to produce a corresponding laser power. The method comprises the steps of:
a) generating a control voltage with reference to a target value and a feedback value from a laser power detector;
b) selecting the control voltage, and enabling a variable gain amplifier to amplify the control voltage by a variable gain value so as to generate the drive voltage for a desired recording speed;
c) prior to end of interruption of a recording or reading process, generating a calculated variable gain value based on a predefined relationship among the control voltage, the drive voltage, the variable gain value in step b), and the target value; and
d) at the end of interruption of the recording or reading process, selecting the target value, and enabling the variable gain amplifier to amplify the target value by the calculated variable gain value so as to generate the drive voltage that is in accordance with the desired recording speed prior to interruption of the recording or reading process for enabling accurate open-loop control.

According to another aspect of the invention, there is provided an automatic laser power control apparatus, which can be used in an optical recording system to generate a drive voltage for causing a laser diode to produce a corresponding laser power. The apparatus comprises:
a drive voltage generator operable so as to output selectively a control voltage for closed-loop control and a target value for open-loop control, and so as to amplify the selected one by a variable gain value in order to generate the drive voltage; and
a zero transient response control unit coupled to the drive voltage generator.

Prior to interruption of a recording or reading process, the zero transient response control unit generates a calculated variable gain value based on a predefined relationship among the control voltage, the drive voltage, the variable gain value, and the target value.

At the end of interruption of the recording or reading process, the zero transient response control unit enables the drive voltage generator to output the target value for open-loop control and to amplify the target value by the calculated variable gain value so as to generate the drive voltage that is the same as that prior to interruption of the recording or reading process for data linking.

### BRIEF DESCRIPTION OF THE DRAWINGS

Other features and advantages of the present invention will become apparent in the following detailed description of the preferred embodiment with reference to the accompanying drawings, of which:

FIG. 1 is a simplified schematic block diagram of an optical recording system with a conventional automatic laser power control apparatus;

FIG. 2 illustrates laser power transient response of the optical recording system of FIG. 1 when its operating mode switches from record mode to read mode, then back to record mode;

FIG. 3 is a schematic block diagram to illustrate a conventional automatic laser power control apparatus disclosed in EP 1231602;

FIG. 4 illustrates laser power transient response of the control apparatus in FIG. 3 under CAV write mode condition;

FIG. 5 is a simplified schematic block diagram of the preferred embodiment of an automatic laser power control apparatus according to the present invention;

FIG. 6 is a schematic electrical circuit diagram of a control voltage generator used in the preferred embodiment of FIG. 5;

FIG. 7(a) illustrates how the laser power changes when operation of the optical recording system changes between record and read modes under CAV write condition;

FIG. 7(b) illustrates the associated drive voltage (V_{d}) corresponding to the condition of FIG. 7(a); and

FIG. 8 is a flowchart to illustrate the preferred embodiment of an automatic laser power control method according to the present invention.

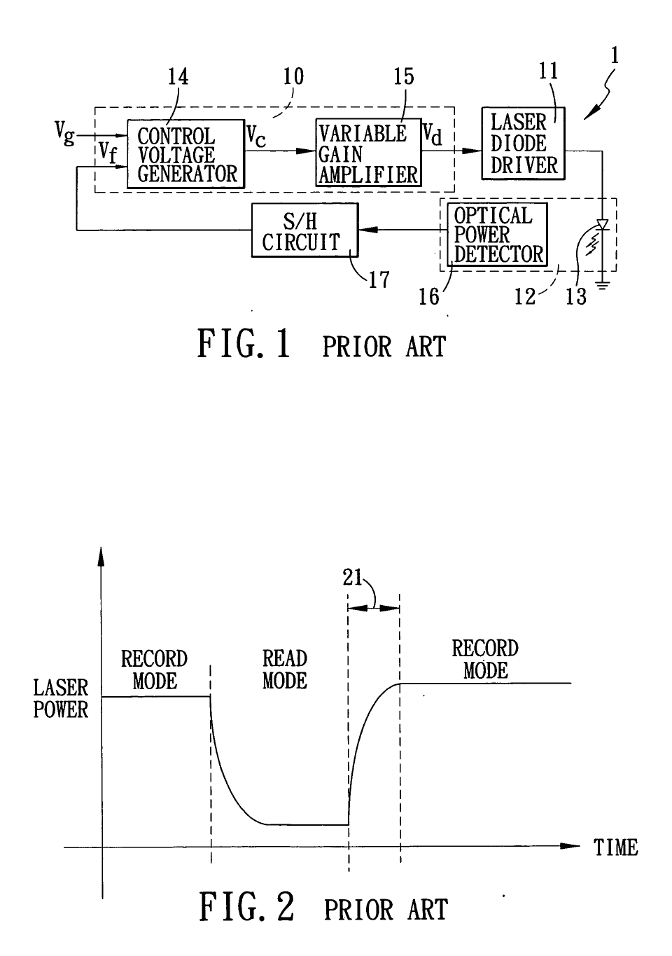

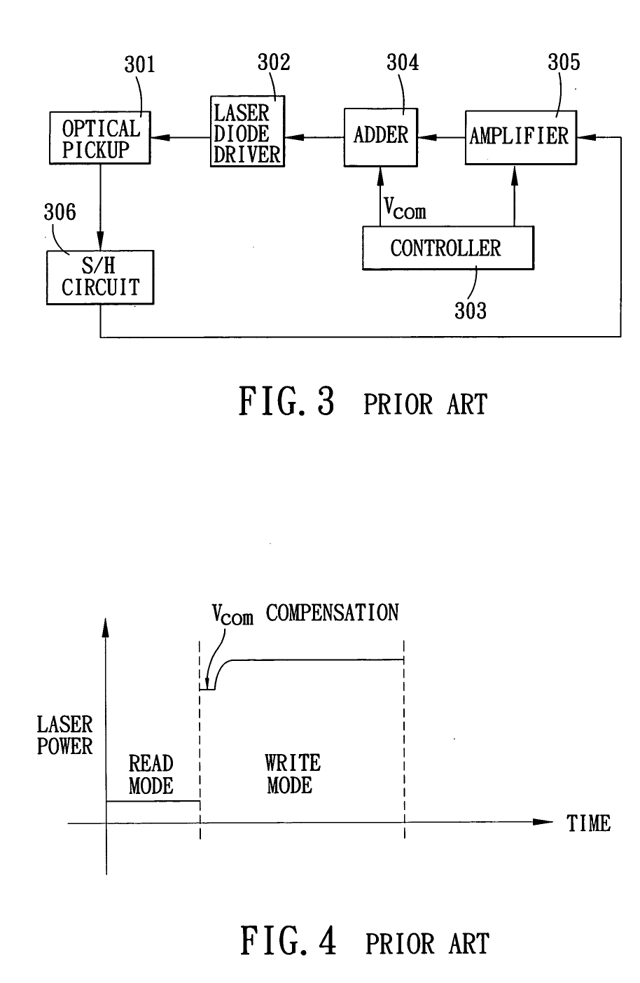

### DETAILED DESCRIPTION OF THE PREFERRED EMBODIMENT

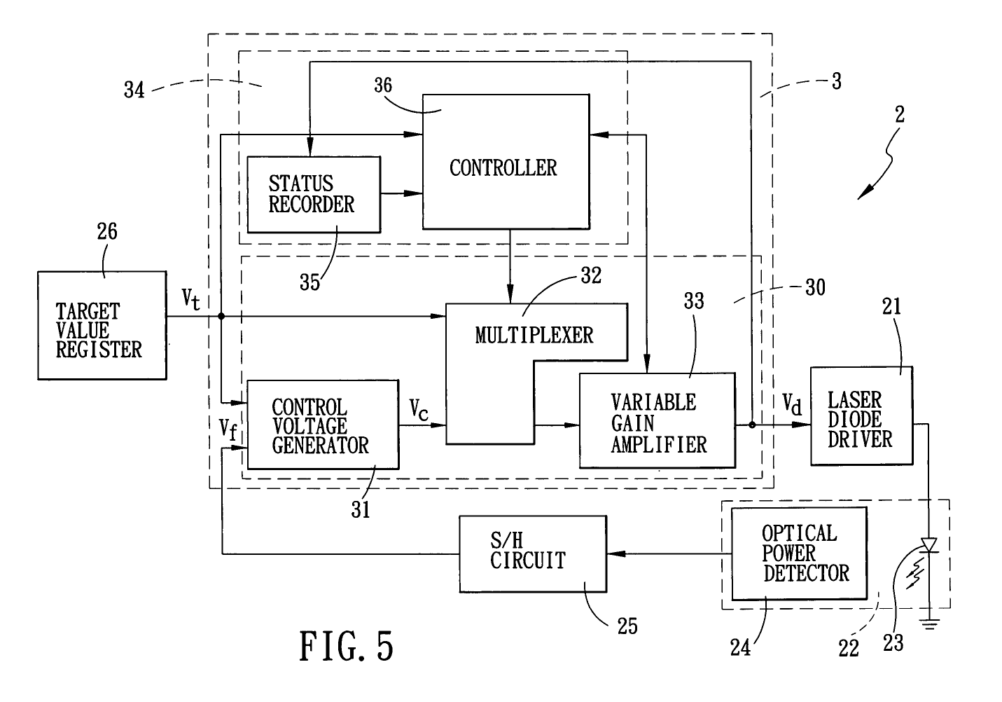

FIG. 5 illustrates a preferred embodiment of a zero transient response automatic laser power control apparatus (hereinafter referred to as automatic laser power control apparatus 3) according to this invention that is suited for variable target and environmental factors. The automatic laser power control apparatus 3 is adapted for use in an optical recording system 2 (such as an optical disc drive), and serves to generate a drive voltage (V_{d}) that is provided to a laser diode driver 21 of the optical recording system 2 for driving a laser diode 23 of an optical pickup 22 to produce a corresponding laser power.

The automatic laser power control apparatus 3 includes a drive voltage generator 30 and a zero transient response control unit 34. The drive voltage generator 30 includes a control voltage generator 31, a multiplexer 32 and a variable gain amplifier 33.

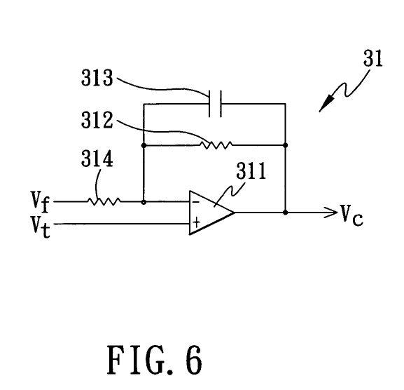

With further reference to FIG. 6, an exemplary control voltage generator 31 is shown to include an operational amplifier 311, and a resistor 312 and a capacitor 313, each of which has one end coupled to an inverting input of the operational amplifier 311, and the other end coupled to an output of the operational amplifier 311. The inverting input of the operational amplifier 311 is further coupled to a resistor 314, which receives a feedback value (V_{f}) (which is a voltage signal) from the optical power detector 24. In the meanwhile, sample-and-hold (S/H) circuit 25 mainly works in the record mode and should be always conducting when in the read mode. The non-inverting input of the operational amplifier 311 receives a target value (Vₜ), which is also a voltage signal and which represents the output power command to the system. The operational amplifier 311 generates a control voltage (V_{c}) based on the difference between the target value (Vₜ) and the feedback value (V_{f}). The feedback value (V_{f}) is a value generated by the sample-and-hold (S/H) circuit 25 of the optical recording system 2, which samples and holds a feedback signal generated by an optical power detector 24 of the optical pickup 22 for detecting corresponding laser power. The target value (Vₜ) is obtained mainly from a target value register 26 through some digital-to-analog conversion technique of the optical recording system 2. When the optical recording system 2 operates in the CAV record mode, the target value (Vₜ) varies in accordance with the continuous increase of the recording speed in a manner well known to those skilled in the art.

The multiplexer 32 is coupled to the control voltage generator 31, the target value register 26 and the variable gain amplifier 33. The multiplexer 32 receives the target value (Vₜ) and the control voltage (V_{c}) as inputs, and is operable so as to select one of the target value (Vₜ) and the control voltage (V_{c}) for output to the variable gain amplifier 33.

The variable gain amplifier 33 has again value (G₁), and serves to amplify the control voltage (V_{c}) outputted by the multiplexer 32 so as to generate the drive voltage (V_{d}). When the multiplexer 32 selects the control voltage (V_{c}) for output, laser power is in closed-loop control in sequence of the control voltage generator 31, the multiplexer 32, the variable gain amplifier 33, the laser diode driver 21, the optical pickup 22 and the S/H circuit 25. When the multiplexer 32 selects the target value (Vₜ) for output, laser power open-loop control is formed in sequence by the target value register 26, the multiplexer 32, the variable gain amplifier 33, the laser diode driver 21, and the optical pickup 22.

The zero transient response control unit 34 includes a status recorder 35 and a controller 36. The status recorder 35 is coupled to the variable gain amplifier 33, and serves to save operation parameters, for example, the drive voltage (V_{d}) generated by the variable gain amplifier 33. The controller 36 is used to control operation of the multiplexer 32 and the gain of the variable gain amplifier 33. It is also coupled to the status recorder 35 and the target value register 26.

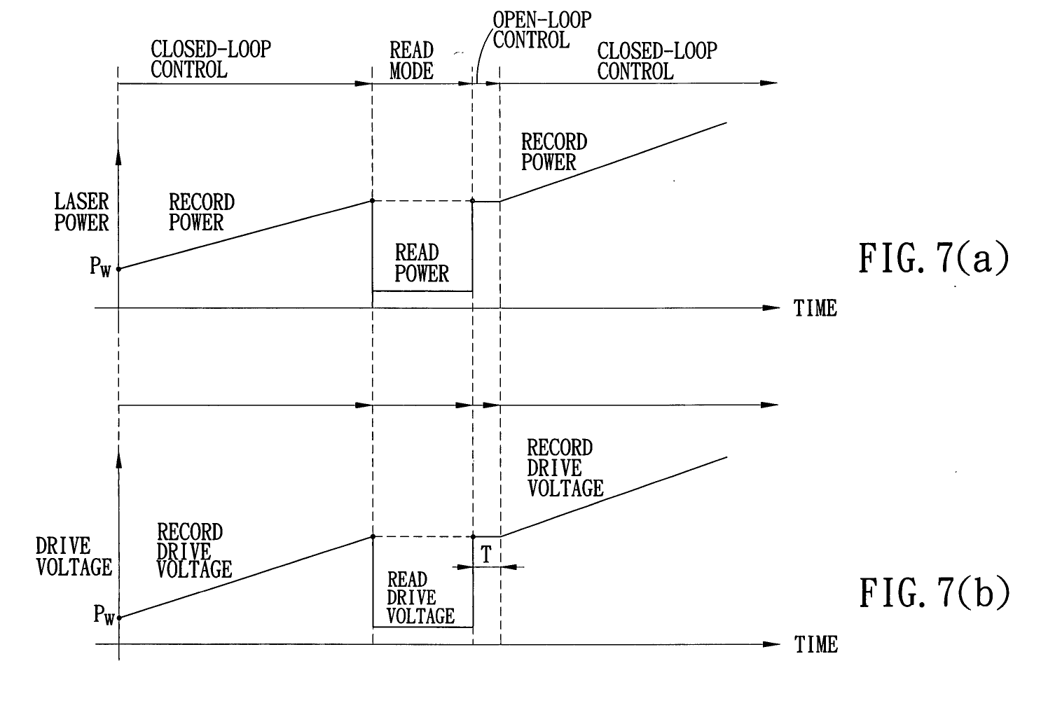

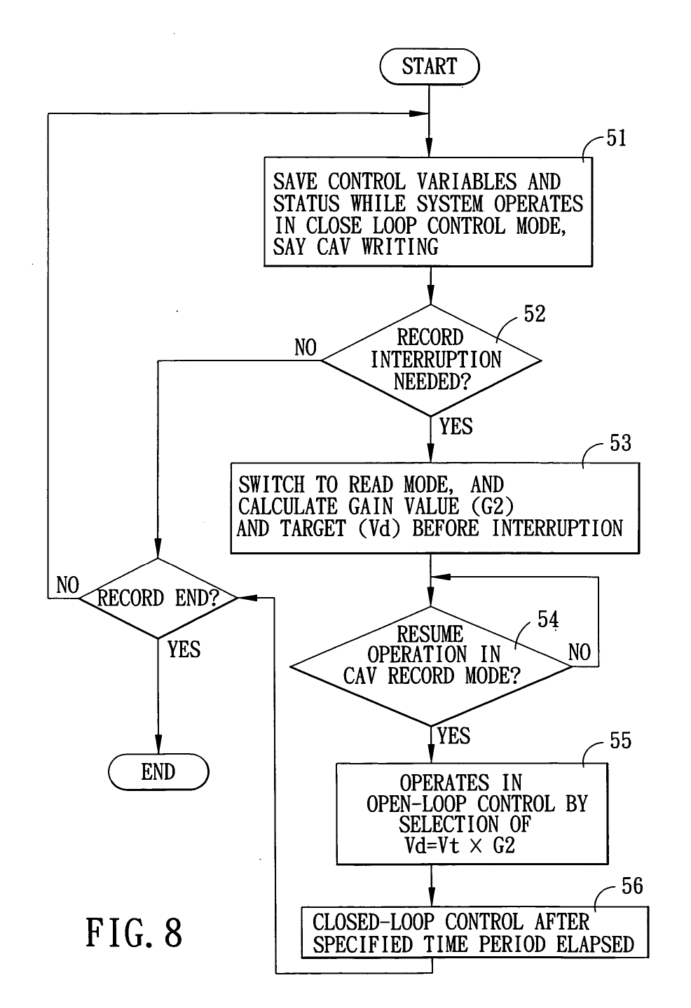

Referring to FIGS. 7(a), 7(b) and 8, when the optical recording system 2 operates in the CAV record mode for writing data to an optical disc (not shown), the automatic laser power control apparatus 3 operates in closed-loop control. At this time, the target value (Vₜ) increases with the gradual increase in the recording speed (such as from 22×CD linear velocity to 52× or DVD from 6× to 16×), and both the drive voltage (V_{d}) and the laser power generated in accordance with the target value (Vₜ) increase as well. In addition, the status recorder 35 saves the drive voltage (V_{d}), which is generated for each distinct disc linear velocity (see step 51 in FIG. 8). Thereafter, when the optical recording system 2 encounters an interruption condition, such as “buffer-under-run” condition during the recording process (see step 52 in FIG. 8), the record mode will be interrupted and switched to a read mode (see step 53 in FIG. 8), in which a low laser power is generated, which is insufficient for disc writing. This situation lasts until more data arrives.

Subsequently, during operation in the read mode, the controller 36 retrieves from the status recorder 35 the drive voltage (V_{d}) saved prior to interruption of the write power, and uses the target value (Vₜ) from the target value register 26 and the current gain value (G₁) of the variable gain amplifier 33 to generate a calculated gain value (G₂) corresponding to the target value (Vₜ) based on the relation V_{c}×G₁=V_{d}=Vₜ×G₂. The calculated gain value (G₂) and the target value (Vₜ) are then used to maintain the drive voltage (V_{d}) unchanged (step 53 when the new writing begins to link data). As a result, the calculated gain value (G₂) of the variable gain amplifier 33 and the target value (Vₜ) from the target value register 26 satisfy the relation V_{c}×G₁=V_{d}=Vₜ×G₂ and are in unchanged power upon link.

The above innovation will now be explained in detail as follows. Resumption of the recording operation in the optical recording system 2 happens when the “buffer-under-run” condition no longer exists (see step 54 in FIG. 8). The controller 36 enables the multiplexer 32 to select the target value (Vₜ), and uses the calculated gain value (G₂) of the variable gain amplifier 33 for open-loop control (see step 55 in FIG. 8) to achieve zero transient response for the automatic laser power control apparatus 3 at the instant the optical recording system 2 switches back to the record mode. The output voltage of the variable gain amplifier 33 is thus equal to the drive voltage (V_{d}) prior to interruption. Therefore, during open-loop control, the laser power generated by the laser diode 23 will be the same as that at the time prior to interruption.

After open-loop control has persisted for a specified time period (T) (the specified time period T is determined based on system parameters, such as the time constants of the laser diode driver 21, the optical power detector 24, and the S/H circuit 25, of the optical recording system 2), the controller 36 enables the multiplexer 32 to output the control voltage (V_{c}) generated by the control voltage generator 31 for proceeding with closed-loop laser power control (see step 56 in FIG. 8). As such, the optical recording system 2 can continue with the CAV record mode, and the status recorder 35 can continue to save the operation parameters, such as the drive voltage (V_{d}), the control voltage (V_{c}), the feedback value (V_{f}), the variable gain value (G₁), the target value (Vₜ), the recording speed, etc. in step 51.

It is apparent from the foregoing that, in the preferred embodiment of this invention, when the optical recording system 2 proceeds with the CAV record mode, the status recorder 35 is used to save the drive voltages (V_{d}) generated during the different recording speeds. Before the recording (or reading process) is interrupted, the controller 36 obtains the drive voltage (V_{d}) prior to interruption from the status recorder 35, and retrieves the gain value (G₁) of the variable gain amplifier 33 and the target value (Vₜ). Based on the relation V_{c}×G₁=V_{d}=Vₜ×G₂, the controller 36 generates the calculated gain value (G₂) for the variable gain amplifier 33 and corresponding to the target value (Vₜ). At the instant the optical recording system 2 switches from the read mode back to the record mode, open-loop control is first performed, and with the use of the target value (Vₜ) and the calculated gain value (G₂), the same drive voltage (V_{d}) and laser power at the time of interruption are thus generated. Accordingly, regardless whatever the target value (Vₜ) is, the controller 36 can still find from the status register 35 the drive voltage (V_{d}) corresponding to the target value (Vₜ) at the time prior to interruption, so that the same laser power is generated after the interruption when the variable gain amplifier 33 is set by (G₂) and the target value (Vₜ) is switched for control at the onset of recording. Thereafter, the controller 36 initiates closed-loop control after a specified time period (T) determined based on system parameters of the optical recording system 2, thereby achieving the effect of eliminating transient response.

In addition, since the status recorder 35 saves the drive voltages (V_{d}) generated during the recording process of the optical recording system 2 in real-time, when the recording method of the optical recording system 2 is non-sequential and involves dynamic jumping, the controller 36 can, with reference to the recording speeds at different positions of the optical disc, find the drive voltage (V_{d}) saved for a specific recording speed from the status recorder 35, and determine the calculated gain value (G₂) of the variable gain amplifier 33 for the specific recording speed so that the laser diode 23 can accurately generate the corresponding laser power for the specific recording speed.

Moreover, while the preferred embodiment was exemplified using the CAV record mode, it should be apparent to those skilled in the art that the invention is also applicable to the CLV record mode or read mode where the target value is fixed.

It has thus been shown that the automatic laser power control apparatus 3 of this invention is indeed capable of achieving zero transient response in an environment where the target value is variable.

While the present invention has been described in connection with what is considered for the most practical and preferred embodiment, it is understood that this invention is not limited to the disclosed embodiment but is intended to cover various arrangements included within the spirit and scope of the broadest interpretation so as to encompass all such modifications and equivalent arrangements.

1. An automatic laser power control method which can be used in an optical recording system to generate a drive voltage for causing a laser diode to produce a corresponding laser power, said method comprising the steps of:
a) generating a control voltage with reference to a target value and a feedback value from a laser power detector;
b) selecting the control voltage, and enabling a variable gain amplifier to amplify the control voltage by a variable gain value so as to generate the drive voltage for a desired recording speed;
c) prior to end of interruption of a recording or reading process, generating a calculated variable gain value based on a predefined relationship among the control voltage, the drive voltage, the variable gain value in step b), and the target value; and
d) at the end of interruption of the recording or reading process, selecting the target value, and enabling the variable gain amplifier to amplify the target value by the calculated variable gain value so as to generate the drive voltage that is in accordance with the desired recording speed prior to interruption of the recording or reading process for enabling accurate open-loop control.

2. The automatic laser power control method of claim 1, wherein, in step d), the flow goes back to step b) after a specified time period.

3. The automatic laser power control method of claim 2, wherein the specified time period is determined based on a time constant of the associated laser power control system.

4. The automatic laser power control method of claim 1, wherein the target value is provided by a target value register of the optical recording system, and, in a CAV record mode, the target value is a variable that changes with the recording speed.

5. The automatic laser power control method of claim 1, wherein step b) includes saving at least one operation parameter selected from the group consisting of the drive voltage, the control voltage, the feedback value, the variable gain value, the target value and the recording speed.

6. The automatic laser power control method of claim 5, wherein, in step c), the calculated variable gain value is generated from said at least one operation parameter saved in step b).

7. An automatic laser power control apparatus which can be used in an optical recording system to generate a drive voltage for causing a laser diode to produce a corresponding laser power, comprising:
a drive voltage generator operable so as to output selectively a control voltage for closed-loop control and a target value for open-loop control, and so as to amplify the selected one by a variable gain value in order to generate the drive voltage; and
a zero transient response control unit coupled to said drive voltage generator;
wherein, prior to interruption of a recording or reading process, said zero transient response control unit generates a calculated variable gain value based on a predefined relationship among the control voltage, the drive voltage, the variable gain value, and the target value; and
wherein, at the end of interruption of the recording or reading process, said zero transient response control unit enables said drive voltage generator to output the target value for open-loop control and to amplify the target value by the calculated variable gain value so as to generate the drive voltage that is the same as that prior to interruption of the recording or reading process for data linking.

8. The automatic laser power control apparatus of claim 7, wherein said drive voltage generator includes:
a control voltage generator for generating the control voltage with reference to the target value and a feedback value from a laser power detector of the optical recording system;
a multiplexer for receiving the control voltage and the target value as inputs, and for selecting one of the control voltage and the target value for output; and
a variable gain amplifier with the variable gain value for amplifying said output of said multiplexer so as to generate the drive voltage.

9. The automatic laser power control apparatus of claim 8, wherein, prior to interruption of the recording or reading process, said zero transient response control unit saves at least one operation parameter selected from the group consisting of the drive voltage, the control voltage, the feedback value, the variable gain value, the target value and the recording speed.

10. The automatic laser power control apparatus of claim 9, wherein said zero transient response control unit generates the calculated variable gain value from said at least one operation parameter saved thereby.

11. The automatic laser power control apparatus of claim 10, wherein said zero transient response control unit includes a status recorder and a controller, said status recorder being used to save said at least one operation parameter, said controller being connected to said multiplexer for multiplexer output selection control and to said variable gain amplifier for variable gain value adjustment control.

12. The automatic laser power control apparatus of claim 11, wherein said controller enables said multiplexer to output the control voltage after a specified time period of selecting the target value for resuming closed-loop control.

13. The automatic laser power control apparatus of claim 12, wherein the specified time period is determined based on system parameters of the optical recording system.

14. The automatic laser power control apparatus of claim 7, wherein the target value is provided by a target value register of the optical recording system, and, in a CAV record mode, the target value is a variable that changes with the recording speed.

15. The automatic laser power control apparatus of claim 7, wherein, prior to interruption of the recording or reading process, said zero transient response control unit saves at least one operation parameter selected from the drive voltage, the control voltage, the variable gain value, the target value and the recording speed.

16. The automatic laser power control apparatus of claim 15, wherein said zero transient response control unit generates the calculated variable gain value from said at least one operation parameter saved thereby.

17. The automatic laser power control apparatus of claim 16, wherein said zero transient response control unit includes a status recorder and a controller, said status recorder being used to save said at least one operation parameter, said controller controlling selection between the control voltage and the target value by said drive voltage generator, as well as the variable gain value used by said drive voltage generator for amplifying the selected one of the control voltage and the target value.

18. The automatic laser power control apparatus of claim 17, wherein said controller enables said drive voltage generator to resume closed-loop control after a specified time period of open-loop control.

19. An automatic laser power control apparatus, which is capable of reducing transient response when a control target value changes due to a change in operating mode of an optical recording system, said automatic laser power control apparatus comprising:
a control unit for laser power control;
a zero transient response control unit for saving operation parameters; and
a multiplexer coupled to and controlled by said zero transient response control unit to provide open loop control for reducing transient response and to resume closed-loop control a specified time period after open-loop control.

20. The automatic laser power control apparatus as claimed in claim 19, wherein the operation parameters saved by said zero transient response control unit include the recording speed, and allow the optical recording system to resume recording status in non-sequential mode, while maintaining zero transient response.
